(19) United States
(12) Patent Application Publication
(10) Pub. No.: US 2019/0196028 A1
(43) Pub. Date: Jun. 27, 2019

(54) INTEGRATED SIDE-BY-SIDE PIXEL-ARRAY SENSOR FOR X-RAY BOTH DUAL-ENERGY AND EXTENDED DYNAMIC RANGE SINGLE-ENERGY

(71) Applicant: Linbo Yang, Pleasanto, CA (US)

(72) Inventor: Linbo Yang, Pleasanto, CA (US)

(21) Appl. No.: 16/199,163

(22) Filed: Nov. 24, 2018

Related U.S. Application Data
(60) Provisional application No. 62/596,786, filed on Dec. 9, 2017.

(51) Int. Cl. G01T 1/208; G01T 1/20

(52) U.S. Cl. CPC G01T 1/208; G01T 1/2002; G01T 1/2018

(57) ABSTRACT

A radiation image detector comprises two parallel rows of one dimensional pixel arrays in a single substrate so that the two pixel arrays are precisely aligned and spaced. Each pixel in one pixel array has a corresponding pixel in the other pixel array. Two arrays are responsive to radiation with different sensitivity by applying different scintillating material. When an object moves perpendicular to the both pixel arrays under radiation flux, two sets of correlated radiation images will be generated. By applying software image merging technique, dynamic range can be extended. If a filter material is placed in front of pixel array with more sensitivity then it then becomes a standard dual-energy detector. The pixel array with filter is high-energy (HE) detector and the other array is low-energy (LE) detector.

### FIELD OF THE INVENTION

The present invention pertains generally to the field of linear radiation solid-state image sensor.

### BACKGROUND OF THE INVENTION

Dual energy (DE) X-ray imaging detectors are used to create images at different X-ray energies in order to distinguish between materials of different atomic composition. DE system finds the most popular applications at security baggage inspection, garbage sorting, mineral ore sorting and food safety inspection.

A DE image detector comprises a low-energy (LE) imaging array that is preferentially sensitive to LE x-ray spectrum and a high-energy (HE) imaging array that is preferentially sensitive to HE x-ray spectrum. DE image sensors discriminate between different materials. DE x-ray imaging operate on the principal that different materials have different x-ray absorption spectra. The x-ray absorption spectrum of a specimen's material is a function of the material's elemental composition and its density. The ratios of the average absorption coefficients across a sensor's LE array spectral response and the average absorption coefficients across a sensor's HE array spectral response differ between materials. This difference in the absorption coefficient ratios enables the DE image sensors to discriminate between different materials.

Key requirements of the DE image sensors are good signal-to-noise ratios (SNR's) to improve image quality and the discrimination between materials, and good registration between LE and HE arrays for accurate identification of the material.

A typical DE image sensor consists of a pair of one-dimensional (1D) individual linear diode arrays (LDA). Traditionally, the LE and HE arrays for the DE LDA image sensors are arranged in a “stacked” or front-and-back configuration where the arrays are aligned such that the straight-line x-ray path emanating from the x-ray source and intersecting the pixels of the LE array will continue to impinge on the corresponding pixels of the HE array. A filter that preferentially filters out the LE x-rays is sandwiched between the LE and the HE arrays. The LE array typically includes x-ray scintillating materials that are preferentially sensitive to the LE x-ray spectrum. Likewise, the HE array typically includes x-ray scintillating materials that are preferentially sensitive to the HE x-ray spectrum.

If the two separate individual linear LDA image sensors are arranged in a “side-by-side” configuration, DE operation can also be performed like that described in a prior art.

However, problems arise in the way the prior art is proposed.

The first disadvantage of the prior art is related to general cost and convenience. Currently security X-ray inspection market is a high volume, low cost market and has a long-felt need of cost-cutting, lighter weight and more compact size. Compared with traditional “stacked” front-and-back configuration in the market, the prior art neither provides any advantages regarding cost, weight, size, nor offers any advantages regarding ease of use, ease of production, repairability etc.

The second disadvantage of the prior art is that it does not guarantee good alignment and spacing of pixels at two individual arrays by using discrete components. For dual energy application, one pixel at one array with one energy response is always corresponding to another pixel at the other array with different energy response. Qualitatively, In order to acquire good dual energy image so that software can perform material discrimination, two individual arrays should have precise alignment and spacing. If alignment is poor and spacing is random, it is very difficult for software to match the dual energy correlation images.

The third disadvantage of the prior art is that when pixel size is getting smaller, say below about 0.5 mm, the prior art will have very poor quality of dual energy correlation images or even become unusable. Quantitatively, standard machining parts would have about 0.1 mm tolerance, semiconductor chips on board and mounting holes location also about 0.1 mm tolerance, plus additional human eye tolerance, error propagation etc. can go either positive or negative direction randomly. In other words, the prior art using discrete components suggested an insolvable problem for dual energy application when pixel sizes go smaller.

The fourth disadvantage of the prior art is that so far its commercial viability has been minimal. Currently, traditional “stacked” top-down configuration is still the most popular configuration in the market.

The fifth disadvantage of the prior art is that it did not suggest supporting for advanced pixel binning feature in order to support variable pixel size. Specific application is usually tied to specific pixel sizes. For example, currently security X-ray inspection is usually with 1.6 mm pixel size while food inspection is with 0.8 mm or even 0.4 mm pixel size. If somehow the side-by-side configuration can do both 0.8 mm and 1.6 mm in one detector setup, chance of commercial success would be much bigger.

The sixth disadvantage of the prior art is that it did not suggest a new use of side-by-side configuration regarding increasing detector image dynamic range if filter thickness is about zero. Just like at in a general digital image, dynamic range means the range of tonal difference between the lightest light and darkest dark of an image. In some cases of digital radiographic applications, an X-ray digital real-time image with high dynamic range needs to be acquired, for example, a doctor would love to see a real-time image that can show details of larger bone structures and fine structures of nearby soft tissues at the same time.

When filter material gets lighter, thinner (about zero thickness), or there is no filter at all, the side-by-side arrays would response more or less the same X-ray energy but with different sensitivities. For the same object, LE array then generates less sensitive image of the object (for soft tissue) while HE arrays produce the more sensitive image of the same object (for larger bones). By applying real-time software algorithms, user can merge two images into one image with much deeper image representation. For example, user can acquire a pair of 16 bit scan images with much different sensitivities and merge into a 32 bit image by a fast PC at real time. The 32 bit image would be able to reveal the details of much darker and much brighter area at the same time so that 32 bit image would have much larger dynamic range than that of a 16 bit image.

In current invention, a new “side-by-side” configuration with two-array sensor on must-be one substrate is proposed. It is built inside a piece of single substrate in order to guarantee the precise pixel alignment and spacing. Unlike that in the prior art where two separate individual sensors are needed, the new two-array sensor is one single chip solution, therefore fabrication cost is greatly reduced and can apply to much smaller pixel sizes. There are much more applications in much smaller pixel sizes.

One variation is to use a time-delayed integration (TDI) sensor to perform the same side-by-side functions when software can read out TDI sensor each line individually. A TDI sensor usually already has a plurality of parallel correlated rows. The TDI sensor automatically has a built-in “side-by-side” configuration with precise pixel alignment and spacing. User can select one row as a LE row and another one row as a HE row. Therefore, DE operation in current invention can also be performed by a TDI detector.

### SUMMARY OF THE INVENTION

The present invention is directed to a detector system for providing cost-effective solution in both extended dynamic range single-energy detector and dual energy (DE) x-ray detector.

A radiation image detector comprises two parallel rows of one dimensional pixel arrays in a single substrate so that the two pixel arrays are precisely aligned and spaced.

Each pixel in one pixel array has a corresponding pixel in the other pixel array. Two arrays are responsive to radiation with different sensitivity by applying different scintillating material.

The pixel arrays are facing to the x-ray source so that x-ray photons follow a straight line that intersects the X-ray source and corresponding set of pixels in the set of arrays.

On the one hand, if filter thickness is about zero or no filter at all, when an object moves perpendicular to the both pixel arrays under radiation flux, two sets of correlated radiation images will be generated. One is much darker image, the other is much brighter. By applying software image merging, dynamic range can be extended.

On the other hand if a filter material with reasonable thickness is placed in front of pixel array with more sensitivity then it becomes a standard dual-energy detector. The pixel array with filter is high-energy (HE) detector and the other array is low-energy (LE) detector.

The two arrays have peripheral circuits comprising pixel signal processing circuits, global video signal processing circuits and timing generators which generate all control clocks necessary for operation of the detectors.

The peripheral circuit can be either in the same substrate as that of two arrays or in a separate substrate. It is also compatible with standard electronics of integrated LDA detectors.

Various other features and advantages of the present invention will be made apparent from the following detailed description and the drawings.

### BRIEF DESCRIPTION OF THE DRAWINGS

FIG. 1 shows a typical dual energy application in which two side-by-side arrays and processing circuits are in a single substrate.

FIG. 2 shows two linear arrays and their processing circuit in a single substrate.

FIG. 3 shows a basic side-by-side dual energy X-ray detector in a single substrate after shielding and filter are in place.

FIG. 4 shows a long side-by-side X-ray detector can be achieved by cascading multiple basic detectors.

FIG. 5 shows two linear arrays and their processing circuit in separate substrate.

FIG. 6 shows a dual energy application in which two side-by-side arrays and processing circuits are in separate substrates.

FIG. 7 shows a basic single energy detector with extended dynamic range in separate substrates after shielding is in place.

FIG. 8 shows a typical single energy application with extended dynamic range in which two side-by-side arrays and processing circuits are in a single substrate.

FIG. 9 shows a single energy application with extended dynamic range in which two side-by-side arrays and processing circuits are in separate substrates.

FIG. 10 shows an advanced pixel binning feature of the current invention where two different pixel sizes can be achieved in one setup.

### DETAILED DESCRIPTION OF THE INVENTION

The present invention is a versatile X-ray linear detector. This detector has a precise side-by-side configuration of two row sensor pixel arrays 13. This has dual functionalities. With an external filter material 11, it serves a dual energy detector; without filter material 11, it can extend dynamic range for a single energy X-ray detector.

For the side-by-side configuration detector to work with different pixel sizes, two sensor pixel arrays 13 must be precisely arranged in the same pixel array substrate 14 so that two arrays are precisely parallel and distance between two corresponding pixels are precisely the same.

Signal processing circuit 9 can be in the same pixel array substrate 14, or can be in a different substrate as processing circuit substrate 10. Two sensor pixel arrays 13 are attached with two kinds of scintillating material. One with more sensitive scintillating material 4, the other array is with less sensitive scintillating material 5.

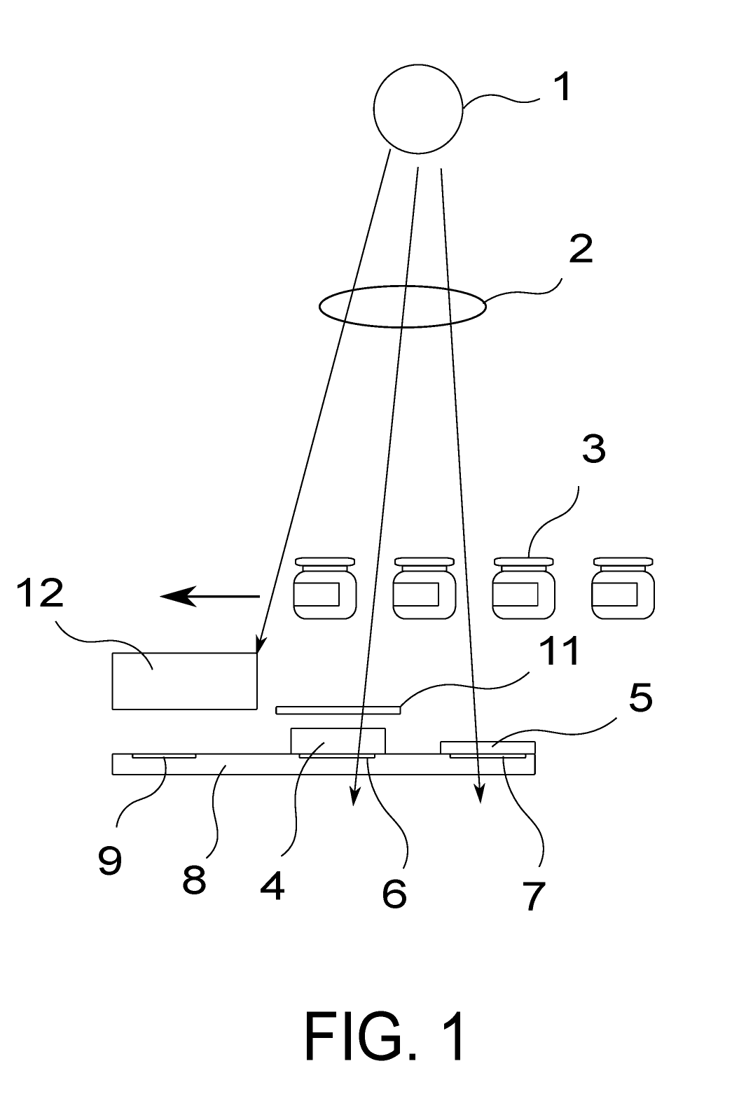

FIG. 1 shows a typical implementation of a side-by-side dual energy application when two sensor pixel arrays 13 and processing circuit 9 in a single integrated sensor substrate 8.

X-ray source 1 generates X-ray beam 2. When scan objects 3 pass through X-ray beam 2, the image signal will be registered in the two parallel sensor pixel arrays 13. Usually shielding material 12 is needed to protect processing circuit 9.

External filter material 11 is placed in front of the array with more sensitive scintillating material 4, so this array is also called high energy sensor array 6; the array with less sensitive scintillating material 5 is also call low energy sensor array 7. In application, side-by-side configuration is not sensitive to direction of scan object 3 motion. Scan object 3 can either reach low energy sensor array 7 first or can reach high energy sensor array 6 first.

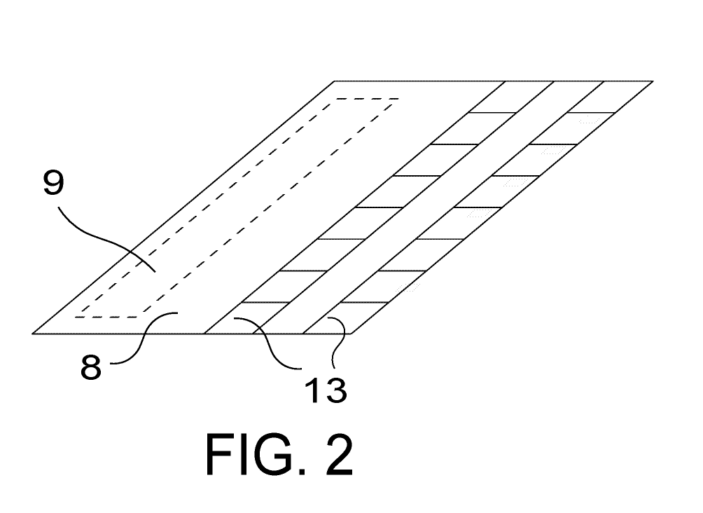

Referring to FIG. 2, two sensor pixel arrays 13 and processing circuit 9 are in a single integrated sensor substrate 8 are shown. Usually the single integrated sensor substrate 8 can be mounted in material like printed circuit board (PCB), glass etc

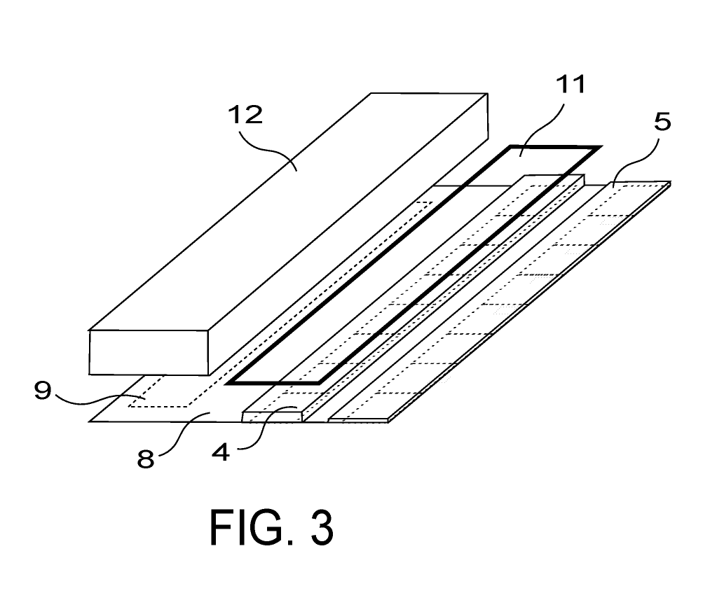

FIG. 3 shows a basic dual energy X-ray detector. Two sensor pixel arrays 13 and processing circuit 9 are in a single integrated sensor substrate 8. One array is attached with more sensitive scintillating material 4; the other array is attached with less sensitive scintillating material 5. External filter material 11 is placed in front of the array with more sensitive scintillating material 4. Shielding material 12 is needed to protect processing circuit 9. In this case, external filter material 11 and shielding material 12 are close to each other so that one option is to mount external filter material 11 on shielding material 12.

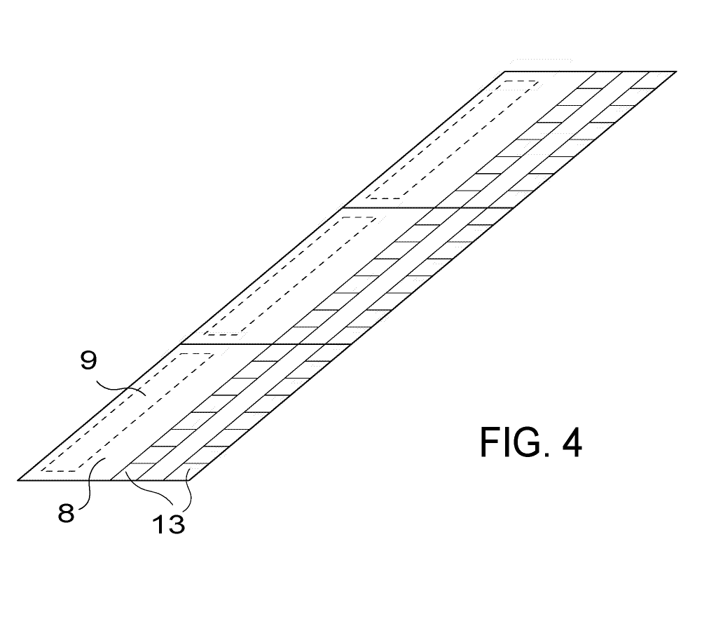

FIG. 4 shows that side-by-side x-ray detectors can be made to be buttable so that the detector can be cascaded to specific length. In this case, there is no limit on total length.

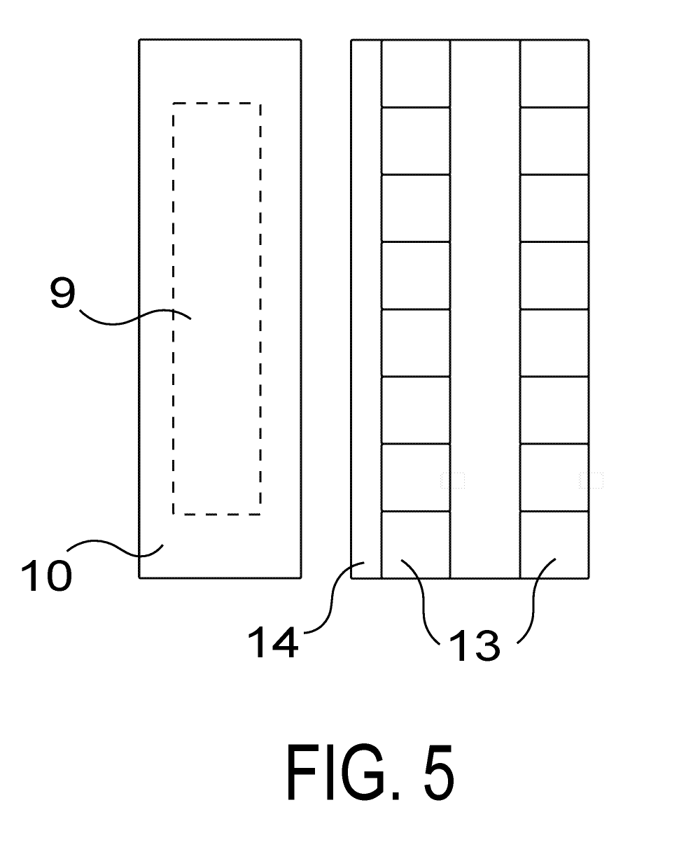

FIG. 5 shows two sensor pixel arrays 13 and processing circuit 9 in separate substrates. Two sensor pixel arrays 13 are in pixel array substrate 14; processing circuit 9 is in processing circuit substrate 10. Connection between sensor pixel arrays 13 and processing circuit 9 can be achieved through wire bonding on substrate.

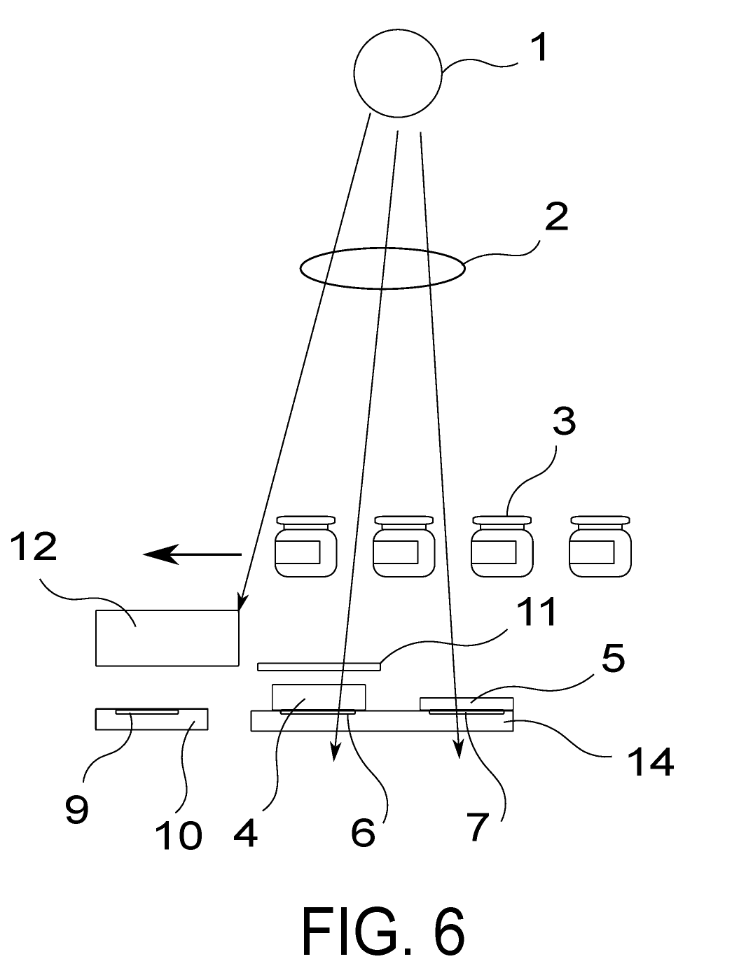

FIG. 6 is an alternative implementation of a side-by-side dual energy application when two sensor pixel arrays 13 and processing circuit 9 in separate substrates.

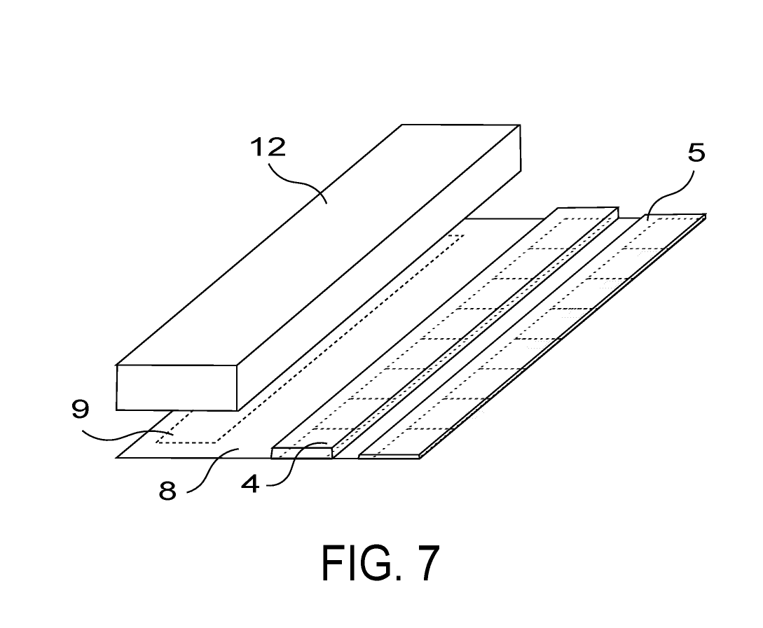

FIG. 7 shows a basic dual row X-ray detector to extend dynamic range. Two sensor pixel arrays 13 and processing circuit 9 are in a single integrated sensor substrate 8. One array is attached with more sensitive scintillating material 4; the other array is attached with less sensitive scintillating material 5. Shielding material 12 is needed to protect processing circuit 9. In this case, no filter material 11 is needed.

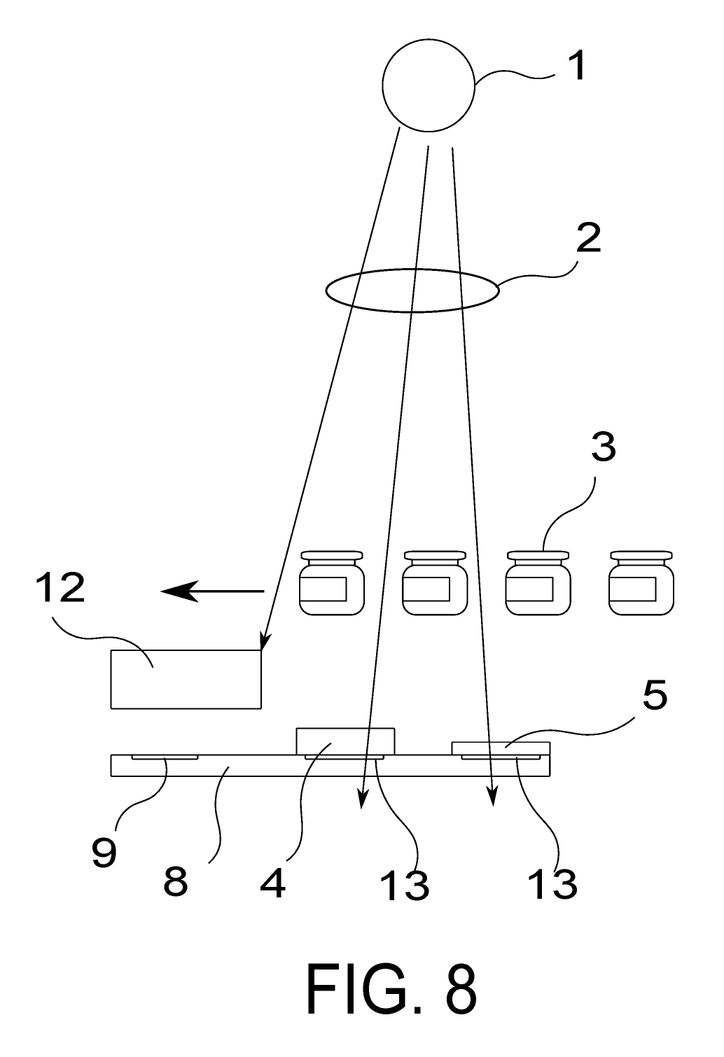

FIG. 8 shows typical implementation of a side-by-side dual row linear detector to extend dynamic range when two sensor pixel arrays 13 and processing circuit 9 in a single integrated sensor substrate 8.

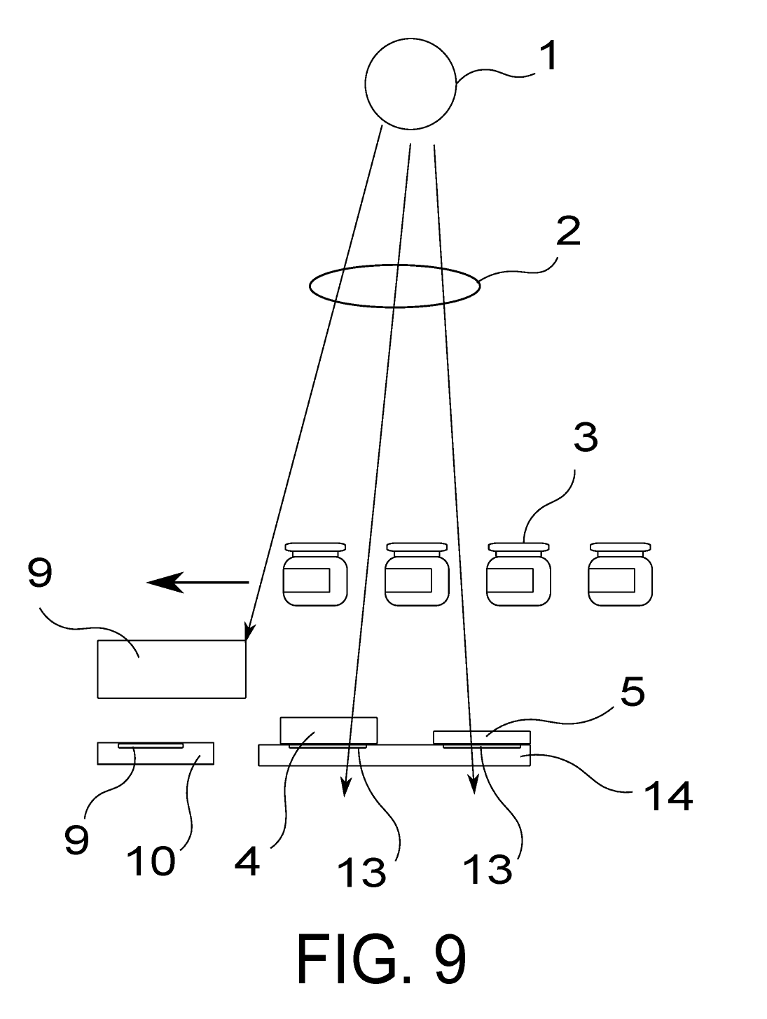

FIG. 9 shows an alternative implementation of a side-by-side row linear detector to extend dynamic range when two sensor pixel arrays 13 and processing circuit 9 in separate substrates.

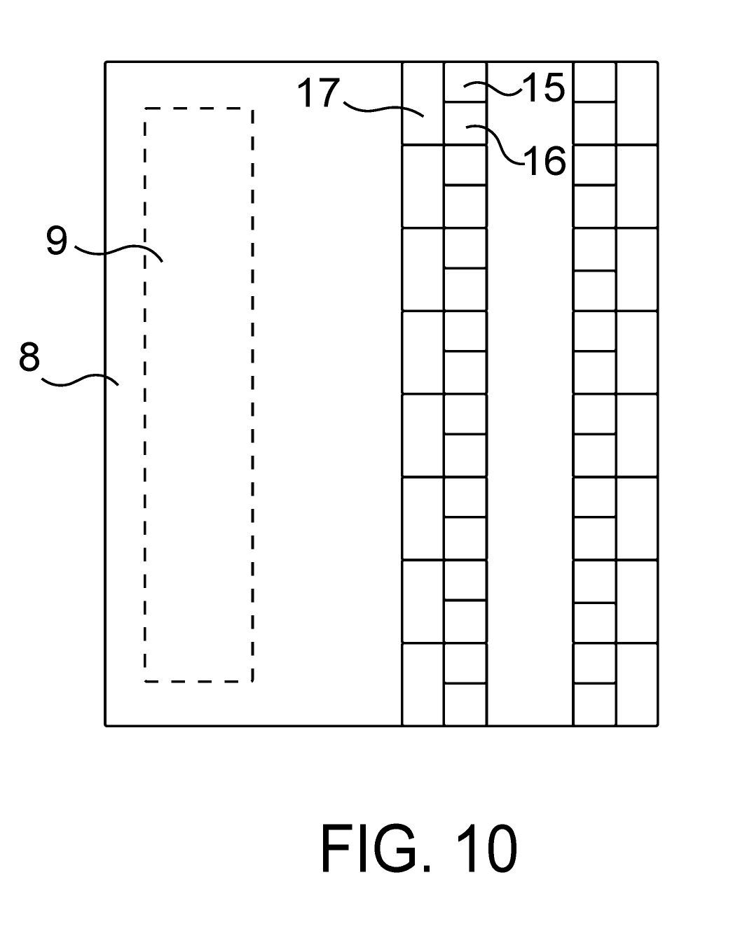

FIG. 10 shows an advanced pixel binning feature over prior art. X-ray detector can run with two different pixel size modes can in one setup. In mode One, i.e. larger pixel mode: larger pixel size is equal to the sum of the first inner smaller pixel 15, the second smaller pixel 16 and one outer larger pixel 17; in mode Two, i.e. smaller pixel mode: data acquisition ignores the outer larger pixel, and only cares about the data from inner smaller pixels.

The above disclosure is not intended as limiting. Those skilled in the art will readily observe that variations and alterations of the device may be made while retaining the teachings of the invention. Accordingly, the above disclosure should be construed as limited only by the restrictions of the following claims.

I claim:

1. A radiation detector comprising:
a first element array responsive to radiation to provide a first radiation response;
a second element array responsive to radiation with different sensitivity to provide a second radiation response, the second element array being positioned to receive radiation independently of the first element array, the first and second element array placed parallel to each other in the same substrate.

2. The radiation detector of claim 1, wherein each said element array comprises:
A scintillating material layer and a sensor array coupled to the scintillating material layer to provide an indication of the corresponding radiation response.

3. The radiation detector of claim 1, wherein photodiode detectors have peripheral circuits comprising pixel signal processing circuits, global video signal processing circuits and timing generators which generate all control clocks necessary for operation of the detectors.

4. The radiation detector of claim 1, wherein it includes time-delayed integration TDI type detector.

5. The radiation detector of claim 2, wherein said indication is a video signal.

6. A radiation detector comprising:
a first element array responsive to radiation to provide a first radiation response;
a second element array responsive to radiation with different sensitivity to provide a second radiation response, the second element array being positioned to receive radiation independently of the first element array, the first and second element array placed parallel to each other in the same substrate;
a filter coupled to the second element to enhance the second radiation response independently of the first radiation response.

7. The radiation detector of claim 6, wherein each said element array comprises:
A scintillating material layer and a sensor array coupled to the scintillating material layer to provide an indication of the corresponding radiation response.

8. The radiation detector of claim 6, wherein photodiode detectors have peripheral circuits comprising pixel signal processing circuits, global video signal processing circuits and timing generators which generate all control clocks necessary for operation of the detectors.

9. The radiation detector of claim 6, wherein said filter includes metal, plastic and composite material.

10. The radiation detector of claim 6, wherein it includes time-delayed integration (TDI) type detector.

11. The radiation detector of claim 7, wherein said indication is a video signal.
